(19) United States
(12) Patent Application Publication
(10) Pub. No.: US 2007/0218811 A1
(43) Pub. Date: Sep. 20, 2007

(54) CMP POLISHING SLURRY AND METHOD OF POLISHING SUBSTRATE

(75) Inventors: Yasushi Kurata, Ibaraki (JP); Kazuhiro Enomoto, Ibaraki (JP); Naoyuki Koyama, Ibaraki (JP); Masato Fukasawa, Ibaraki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HITACHI CHEMICAL CO., LTD., Tokyo (JP)

(21) Appl. No.: 11/576,010

(22) PCT Filed: Sep. 25, 2005
(86) PCT No.: PCT/JP05/17747

§ 371 Date: Mar. 26, 2007

(30) Foreign Application Priority Data
Sep. 27, 2004 (JP) 2004-279601
Jun. 20, 2005 (JP) 2005-179464

(51) Int. Cl. C09G 1/00

(52) U.S. Cl. 451/28; 51/309

(57) ABSTRACT

A CMP polishing slurry of the present invention, contains cerium oxide particles, a dispersant, a polycarboxylic acid, a strong acid having a pKa of its first dissociable acidic group at 3.2 or less, and water, the pH of the polishing slurry is 4.0 or more and 7.5 or less, wherein the strong acid is contained 100 to 1,000 ppm or 50 to 1,000 ppm, or the strong acid is a monovalent strong acid contained 50 to 500 ppm or is a bivalent strong acid contained 100 to 1,000 ppm. The preferable polycarboxylic acid is a polyacrylic acid. The present invention allows polishing in the CMP methods of surface-smoothening an interlayer dielectric film, a BPSG film and a shallow-trench-isolation insulation film with high speed operation efficiently and easier process management and cause smaller fluctuation in film thickness due to difference in pattern density.

### TECHNICAL FIELD

The present invention relates to a CMP polishing slurry for use in a step of smoothening the surface of a substrate in production of semiconductor devices, in particular in steps of smoothening an interlayer dielectric film and a BPSG (silicon dioxide film doped with boron and phosphorus) film, forming a shallow trench isolation film, and others, and a method of polishing a substrate by using the CMP polishing slurry.

### BACKGROUND ART

Currently under research and development are processing methods for improvement in density and miniaturization in production of ULSI semiconductor devices. One of the methods, chemical mechanical polishing (CMP) technology, is now a technology essential in production of semiconductor devices, for example, for smoothening of an interlayer dielectric film, forming a shallow trench device separately, and forming plugged and embedded metal wiring.

In production of semiconductor devices, inorganic insulation film layers such as a silicon oxide insulation film are formed by methods such as plasma CVD and low-pressure CVD. Polishing slurries of fumed silica are commonly studied as a conventional chemical mechanical abrasive in state of slurry for use in smoothening the inorganic insulation film layer. The fumed silica polishing slurries are produced by grain growth, for example, by oxidative thermolysis of tetrachlorosilane and subsequent pH adjustment. However, such a polishing slurry still has a problem that the polishing speed is lower.

A shallow trench isolation method has been used for isolation of devices in an integrated circuit in devices in the generation of a design rule of 0.25 μm or later. In the shallow trench isolation method, CMP is used for removal of excessive silicon oxide films formed on a substrate, and a stopper film smaller in polishing speed is formed under the silicon oxide film for termination of polishing. For example, silicon nitride is used for the stopper film, and the difference in polishing speed between the silicon oxide film and the stopper film is preferably greater. Conventional colloidal silica-based polishing slurries have a smaller polishing speed ratio between the silicon oxide film and the stopper film at approximately 3, and thus, did not have properties practically usable for shallow trench isolation.

On the other hand, cerium oxide polishing slurries have been used as abrasives for use on the surface of glasses such as of photomask and lens. Cerium oxide particles are softer than silica or alumina particles, less likely to cause scratching on the polishing surface, and thus, useful for finishing mirror-surface polishing. The particles also have an advantage that the polishing speed therewith is faster than that of silica polishing slurries. Recently, CMP polishing slurries for semiconductor processing containing a high-purity cerium oxide polishing powder have been used. Such methods are described, for example, in Japanese Patent Application Laid-Open No. 10-106994.

Also known is a fact that an additive is added for control of the polishing speed with the cerium oxide polishing slurry and for improvement in global smoothness. Such methods are described, for example, in Japanese Patent Application Laid-Open No. 8-22970.

### DISCLOSURE OF THE INVENTION

However, the polishing slurry of such a cerium oxide had problems that the particle diameter of the polishing powder particles changes easily, causing fluctuation in film thickness due to difference in pattern density. Generally, a region where the areal density of a convex region (active area) where an under layer of STI or the like is coated with silicon nitride is smaller becomes exposed to a greater effective polishing pressure and thus more vulnerable to polishing than a region where the areal density is larger. This consequently leads to the problems of decrease of the residual film thickness of silicon nitride in the low-density area (greater loss in film thickness) and thus, greater fluctuation in film thickness due to difference in pattern density.

The present invention provides a polishing slurry and a polishing method for polishing a silicon oxide film or the like, that allow high speed operation and easier process management and cause smaller fluctuation in film thickness due to difference in pattern density, for use in the CMP methods of surface-smoothening an interlayer dielectric film, a BPSG film and a shallow-trench-isolation insulation film.

The present invention relates to (1) a CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less and the concentration of the strong acid in the polishing slurry is 100 to 1,000 ppm.

The present invention relates to (2) a CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less and the concentration of the strong acid in the polishing slurry is 50 to 1,000 ppm.

The present invention relates to (3) a CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less, the strong acid in the polishing slurry is a monovalent strong acid, and the concentration thereof is 50 to 500 ppm.

The present invention relates to (4) a CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less, the strong acid in the polishing slurry is a bivalent strong acid, and the concentration thereof is 100 to 1,000 ppm.

The present invention relates to (5) the CMP polishing slurry according to (1) or (4), wherein the concentration of the strong acid in the polishing slurry is 200 to 1,000 ppm.

The present invention relates to (6) the CMP polishing slurry according to (1) or (4), wherein the concentration of the strong acid in the polishing slurry is 300 to 600 ppm.

The present invention relates to (7) the CMP polishing slurry according to (1) or (4), wherein the strong acid is a sulfuric acid.

The present invention relates to (8) the CMP polishing slurry according to (2) or (3), wherein the concentration of the strong acid in the polishing slurry is 100 to 500 ppm.

The present invention relates to (9) the CMP polishing slurry according to (2) or (3), wherein the concentration of the strong acid in the polishing slurry is 150 to 300 ppm.

The present invention relates to (10) the CMP polishing slurry according to any one of (1) to (9), wherein the pKa of the first dissociable acidic group of the strong acid is 2.0 or less.

The present invention relates to (11) the CMP polishing slurry according to (10), wherein the pKa of the first dissociable acidic group of the strong acid is 1.5 or less.

The present invention relates to (12) the CMP polishing slurry according to any one of (1) to (11), wherein the pH of the polishing slurry is 4.5 or more and 5.5 or less.

The present invention relates to (13) the CMP polishing slurry according to any one of (1) to (12), wherein the polycarboxylic acid is a polyacrylic acid.

The present invention relates to (14) the CMP polishing slurry according to any one of (1) to (13), wherein the dispersant is a polymer compound containing an ammonium acrylate salt.

The present invention relates to (15) the CMP polishing slurry according to any one of (1) to (14), wherein the polishing slurry is prepared by mixing an unneutralized polycarboxylic acid, a strong acid or a strong acid salt, and water and adjusting the pH of the mixture with ammonia.

The present invention relates to (16) the CMP polishing slurry according to any one of (1) to (15), wherein the content of the cerium oxide particles is 0.1 weight part or more and 5 weight parts or less with respect to 100 weight parts of the CMP polishing slurry.

The present invention relates to (17) the CMP polishing slurry according to any one of (1) to (16), wherein the content of the polycarboxylic acid is 0.01 weight part or more and 2 weight parts or less with respect to 100 weight parts of the CMP polishing slurry.

The present invention relates to (18) the CMP polishing slurry according to any one of (1) to (17), wherein the weight-average molecular weight of the polycarboxylic acid is 500 or more and 20,000 or less (by GPC as PEG).

The present invention relates to (19) the CMP polishing slurry according to any one of (1) to (18), wherein the average particle diameter of the cerium oxide particles is 1 nm or more and 400 nm or less.

The present invention relates to (20) the CMP polishing slurry according to any one of (1) to (19), wherein the polycarboxylic acid is a polymer obtained by polymerization of a monomer containing at least one of carboxylic acid having an unsaturated double bond and the salt thereof by using at least one of cationic or anionic azo compound and the salt thereof as a polymerization initiator.

The present invention relates to (21) the CMP polishing slurry according to any one of (1) to (20), characterized by being prepared by mixing a cerium oxide slurry containing cerium oxide particles, the dispersant and water with a supplementary solution containing the polycarboxylic acid, the strong acid, a pH adjuster and water.

The present invention relates to (22) a method of producing the CMP polishing slurry according to any one of (1) to (21), characterized by including: a step of preparing an aqueous solution containing an unneutralized polycarboxylic acid, a strong acid or a strong acid salt, and water; and a step of adjusting the pH of the aqueous solution with ammonia.

The present invention relates to (23) a method of producing the CMP polishing slurry according to any one of (1) to (21), characterized by including a step of mixing a cerium oxide slurry containing cerium oxide particles, a dispersant and water with a supplementary solution containing a polycarboxylic acid, a strong acid and water.

The present invention relates to (24) a method of polishing a substrate, characterized by pressing a substrate having a formed film to be polished onto a polishing cloth of a polishing table, and polishing the film to be polished by moving the substrate and the polishing table relatively to each other while supplying the CMP polishing slurry according to any one of (1) to (21) into the space between the film to be polished and the polishing cloth.

This application claims priority from Japanese Patent Application No. 2004-279601 filed on Sep. 27, 2004 and Japanese Patent Application No. 2005-179464 filed on Jun. 20, 2005, the entire contents of which are incorporated herein by reference.

The present invention provides a polishing slurry and a polishing method for polishing a silicon oxide film or the like, that allow high speed operation and easier process management and cause smaller fluctuation in film thickness due to difference in pattern density, for use in the CMP methods of surface-smoothening an interlayer dielectric film, a BPSG film and a shallow-trench-isolation insulation film or the like.

### BEST MODE OF CARRYING OUT THE INVENTION

The cerium oxide particles are prepared in general by oxidizing a cerium compound such as a carbonate salt, a nitrate salt, a sulfate salt or oxalate salt. A cerium oxide polishing slurry for use in polishing a silicon oxide film formed, for example, by a TEOS-CVD method allows high-speed polishing, but leaves more polishing scratches, when the crystallite diameter of the particle becomes greater and the crystal distortion becomes smaller, i.e., when the crystallinity thereof is higher. Although the method of producing the cerium oxide particles for use in the present invention is not particularly limited, the crystallite diameter of the cerium oxide is preferably 1 nm or more and 300 nm or less Since the particle is used for polishing during production of semiconductor devices, the content of alkali metals and halogens in the cerium oxide particle is preferably kept, for example, to 10 ppm or less by mass.

In the present invention, the cerium oxide powder can be prepared by calcining or by oxidation with hydrogen peroxide or the like. The calcining temperature is preferably in the range of 350° C. to 900° C.

The cerium oxide particles prepared by the method are preferably pulverized mechanically, because of aggregate. The pulverization method is preferably a dry pulverization method, for example, by using a jet mill, or a wet pulverization method, for example, by using a planetary bead mill. The jet mill is described, for example, in Kagaku Kogaku Ronbunshu (Chemical Engineering Paper Collection), Vol. 6, No. 5 (1980) pp. 527 to 532.

Such cerium oxide particles can be dispersed in water which is a primary dispersion medium, by dispersing the mixture in a homogenizer, an ultrasonic dispersing machine, a wet ball mill, or the like as well as a common stirrer.

Further fine cerium oxide dispersion is prepared by a sedimentation classification method of leaving a cerium oxide dispersion for a long period to allow sedimentation of larger particles and withdrawing a supernatant liquid by a pump. Alternatively, the cerium oxide particles in the dispersion medium may be pulverized further in a high-pressure homogenizer that pulverizes particles by collision under high pressure of more than 90 MPa.

The average particle diameter of the cerium oxide particles in the CMP polishing slurry thus prepared is preferably 1 to 400 nm, more preferably 1 to 300 nm, and still more preferably 1 to 200 nm. An average cerium oxide particle diameter of less than 1 nm may lead to decrease in polishing speed, while an average cerium oxide particle diameter of more than 400 nm may lead to more frequent scratching on the polished film.

The CMP polishing slurry according to the present invention is prepared, for example, by forming a dispersion of cerium oxide particles (A) having the characteristics above, a dispersant (B), and water (C) by blending, and further adding a polycarboxylic acid (D) and a strong acid (E) described below. The concentration of the cerium oxide particles therein is preferably in the range of 0.1 weight part or more and 5 weight parts or less, more preferably 0.2 weight part or more and 3 weight parts or less, with respect to 100 weight parts of the polishing slurry. It is because an excessively lower concentration leads to decrease of polishing speed, while an excessively higher concentration leads to aggregation.

Examples of the dispersants (B) for use include water-soluble anionic dispersants, water-soluble nonionic dispersants, water-soluble cationic dispersants, and water-soluble amphoteric dispersants, and dispersants of a polymer compound containing an ammonium acrylate salt as a copolymerization component are preferable. Examples thereof include ammonium polyacrylate, copolymers of acrylic amide and ammonium acrylate, and the like.

Two or more dispersants containing at least one dispersant of a polymer compound containing an ammonium acrylate salt as the copolymerization component and at least one dispersant selected from water-soluble anionic, water-soluble nonionic, water-soluble cationic, and water-soluble amphoteric dispersants may be used in combination.

Because the dispersant is used in polishing during production of semiconductor devices, the content of alkali metals such as sodium and potassium ions in the dispersant is preferably reduced to 10 ppm or less.

Examples of the water-soluble anionic dispersants include triethanolamine laurylsulfate, ammonium laurylsulfate, triethanolamine polyoxyethylene alkylether sulfates, and polycarboxylic acid-based polymer dispersants.

Examples of the polycarboxylic acid-based polymer dispersants include polymers from a carboxylic acid monomer having an unsaturated double bond such as acrylic acid, methacrylic acid, maleic acid, fumaric acid, or itaconic acid; copolymers from a carboxylic acid monomer having an unsaturated double bond and another monomer having an unsaturated double bond; and the ammonium or amine salts thereof.

Examples of the water-soluble nonionic dispersants include polyoxyethylene laurylether, polyoxyethylene cetylether, polyoxyethylene stearylether, polyoxyethylene oleylether, polyoxyethylene higher alcohol ethers, polyoxyethylene octylphenylether, polyoxyethylene nonylphenylether, polyoxyalkylene alkylether, polyoxyethylene derivatives, polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, polyoxyethyltetraoleate ethylene sorbitol, polyethylene glycol monolaurate, polyethylene glycol monostearate, polyethylene glycol distearate, polyethylene glycol monooleate, polyoxyethylene alkylamine, polyoxyethylene hydrogenated castor oil, 2-hydroxyethyl methacrylate, and alkyl alkanol amides.

Examples of the water-soluble cationic dispersants include polyvinylpyrrolidone, coconut amine acetate, and stearylamine acetate, and examples of the water-soluble amphoteric dispersants include laurylbetaine, stearylbetaine, lauryldimethylamine oxide, and 2-alkyl-N-carboxymethyl-N-hydroxyethylimidazolinium betaine.

The amount of these dispersants added is preferably in the range of 0.01 weight part or more and 10 weight parts or less, with respect to 100 weight parts of the cerium oxide particle, for dispersion and prevention of sedimentation of the polishing particles and from the relationship between the polishing scratch and the amount of the dispersant added. The weight-average molecular weight of the dispersant is preferably 100 to 50,000, more preferably 1,000to 10,000. When the weight-average molecular weight of the dispersant is less than 100, a silicon oxide or silicon nitride film may not be polished at sufficient velocity, while a dispersant having a weight-average molecular weight of more than 50,000 may lead to increase in viscosity and thus, deterioration in storage stability of the CMP polishing slurry.

The CMP polishing slurry according to the present invention has improved surface-smoothening characteristics when it contains a polycarboxylic acid (D). Such a polishing slurry is effective in reducing the polishing speed of stopper film, silicon nitride film, more than that of the main film to be polished, silicon oxide film, and thus, allows easier process management. The polycarboxylic acid may also have a function as a dispersant. Examples of the polycarboxylic acids include polyacrylic acid, polymethacrylic acid, polystyrenecarboxylic acid, and copolymers thereof. Examples of the polycarboxylic acid also include copolymers of a carboxylic acid and another copolymerizable monomer such as an acrylic acid/methyl acrylate copolymer. The copolymerization ratio of the carboxylic acid is preferably 50 weight % or more in such a case. The polycarboxylic acid is preferably a polymer obtained by polymerization of a monomer containing at least one of carboxylic acid having an unsaturated double bond and the salt thereof by using at least one of cationic azo compound and the salt thereof or at least one of anionic azo compound and the salt thereof as a polymerization initiator. Examples of the polymerization initiators include 2,2′-azobis[2-(2-imidazolin-2-yl)propane]bisulfate dihydrate, and 2,2′-azobis[2-(2-imidazolin-2-yl)propane].

A method of producing the polycarboxylic acid for use in the present invention is not particularly limited, and, for example when a polyacrylic acid is used, the polycarboxylic acid preferably has a weight-average molecular weight, as determined by GPC, of 500 or more and 20,000 or less as PEG, more preferably 1,000 or more and 20,000 or less, and particularly preferably 2,000 or more 10,000 or less. An excessively lower molecular weight may lead to insufficient smoothening effect, while an excessively higher molecular weight may lead to easier aggregation of the cerium oxide particles and deterioration of the polishing speed of the convex patterns region.

For example in the case of a polyacrylic acid, the content of the polycarboxylic acid is preferably in the range of 0.01 weight part or more and 2 weight parts or less, more preferably 0.1 weight part or more and 1 weight part or less, with respect to 100 weight parts of the CMP polishing slurry. An excessively smaller content may lead to deterioration in smoothening characteristics, while an excessively higher content may lead to drastic drop of the polishing speed of the convex patterns region and deterioration in dispersion stability of the cerium oxide particles.

The CMP polishing slurry according to the present invention has an improved smoothening characteristics and also reduces fluctuation in film thickness due to difference in pattern density, when it contains the polycarboxylic acid and also a strong acid (E) having a pKa of the first dissociable acidic group at 3.2 or less. It is thus possible to reduce the loss in film thickness of the silicon nitride of the region where the areal density of convex region (active region) where an underlayer of STI or the likes is covered with silicon nitride is smaller.

In the present invention, the strong acid is an acid having a pKa of the first dissociable acidic group (pKₐ₁) at 3.2 or less. Examples of such acids include: sulfuric acid (first dissociation step pKₐ₁: <0, second dissociation step pKₐ₂: 1.96, hereinafter, only first dissociation step pKₐ₁ is shown), hydrochloric acid (−3.7), nitric acid (−1.8), phosphoric acid (2.15), oxalic acid (1.04), maleic acid (1.75), picric acid (0.33), sulfurous acid (1.86), thiosulfuric acid (0.6), amidosulfuric acid (0.99), chloric acid, perchloric acid (<0), chlorous acid (2.31), hydroiodic acid (−10), periodic acid, iodic acid (0.77), hydrobromic acid (−9), perbromic acid, bromic acid, chromic acid (−0.2), nitrous acid (3.15), diphosphoric acid (0.8), tripolyphosphoric acid (2.0), picric acid (0.33), picolinic acid (1.03), phosphinic acid (1.23), phosphonic acid (1.5), isonicotinic acid (1.79), nicotinic acid (2.05), trichloroacetic acid (0.66), dichloroacetic acid (1.30), chloroacetic acid (2.68), cyanoacetic acid (2.47), oxaloacetic acid (2.27), nitroacetic acid (1.46), bromoacetic acid (2.72), fluoroacetic acid (2.59), phenoxyacetic acid (2.99), o-bromobenzoic acid (2.85), o-nitrobenzoic acid (2.17), o-chlorobenzoic acid (2.92), p-aminobenzoic acid (2.41), anthranilic acid (2.00), phthalic acid (2.75), fumaric acid (2.85), malonic acid (2.65), d-tartaric acid (2.83), citric acid (2.90), o-chloroaniline (2.64), 2,2′-bipyridine (2.69), 4,4′-bipyridine (2.69), 2,6-pyridinedicarboxylic acid (2.09), pyruvic acid (2.26), polystyrenesulfonic acid (<3.0), polysulfonic acid (<3.0), glutamic acid (2.18), salicylic acid (2.81), aspartic acid (1.93), 2-aminoethylphosphonic acid (1.1), glycine (2.36), arginine (2.05), isoleucine (2.21), sarcosine (2.15), ornithine (1.9), guanosine (1.8), citrulline (2.43), tyrosine (2.17), valine (2.26), hypoxanthine (2.04), methionine (2.15), lysine (2.04), and leucine (2.35). A sulfuric acid is particularly preferable.

The strong acid is more effective when the pKa of its first dissociable acidic group is lower, and thus, the pKa of the first dissociable acidic group is more preferably 2.0 or less, particularly 1.5 or less. A pKa of the first dissociable acidic group at more than 3.2 may result in insufficient effect. The method of adding a strong acid for use in the present invention is not particularly limited, and the strong acid may be added separately from the polycarboxylic acid, or may be contained in the polycarboxylic.

For example, when the polycarboxylic acid is a polyacrylic acid, which seems to have a pKₐ₁ of 4 to 5 (pKₐ₁ of acrylic acid: 4.26), addition of a more dissociable acid prevents dissociation of the polyacrylic acid and improves the smoothening effect by the polyacrylic acid. The improvement in smoothening effect by addition of the polycarboxylic acid seems to be the result of the surface-protecting action (anti-polishing action of silicon oxide film) by adsorption of the polycarboxylic acid onto the silicon oxide film surface or cerium oxide particle surface. Combined use of a polycarboxylic acid and a strong acid is effective in preventing dissociation of the polycarboxylic acid. Such an effect is probably because of the enhanced hydrogen bonding adsorption of the polycarboxylic acid on the silicon oxide film, but the possible mechanism is not limited thereto in the present invention.

The pKa value in the present invention is described in the literature: “Chemical Handbook (Basic)” Revised Ed., 4th, (Chemical Society of Japan Ed., Sep. 30, 2003, Maruzen Co., Ltd.) pp. II-317 to 322.

The strong acid may be used in the form of salt. Examples of the strong acid salts include ammonium salts such as ammonium sulfate, ammonium nitrate, ammonium oxalate, aluminum sulfite, ammonium nitrite, ammonium amidosulfate, ammonium iodate, ammonium persulfate and ammonium perchlorate.

The content of the strong acid in the polishing slurry should be 100 to 1,000 ppm, preferably 200 to 1,000 ppm, and more preferably 300 to 600 ppm by weight. For example, when a sulfuric acid is used, the content thereof should be in the range of 0.01 weight part or more and 0.1 weight part or less, preferably 0.02 weight part or more and 0.1 weight part or less, and more preferably 0.03 weight part or more and 0.06 weight part or less, with respect to 100 weight parts of the CMP polishing slurry. However, the content of the strong acid in the polishing slurry should be 50 to 1,000 ppm, depending on the kind of the strong acid, for example, when the strong acid is a monovalent acid.

An excessively smaller content of strong acid makes it less effective to reduce pattern density dependency. An excessively large content leads to significant decrease of polishing speed of the convex-pattern region and deterioration in the dispersion stability of cerium oxide particles, and also to enlargement of the particle diameter of the cerium oxide particles even after redispersion after long-term storage. In practice, the normality in the polishing slurry (mole concentration multiplied by valency of acid) should also be taken into consideration, and a strong acid smaller in molecular weight or having greater valency (dissociation steps) is more effective when it is added in the same amount.

The content of the strong acid when it is a monovalent strong acid is preferably 50 to 500 ppm, more preferably 100 to 500 ppm, and particularly preferably 150 to 300 ppm.

The content thereof when it is a bivalent strong acid is preferably 100 to 1,000 ppm, more preferably 200 to 1,000 ppm, and particularly preferably 300 to 600 ppm. When a monovalent strong acid and a bivalent strong acid are blended in the polishing slurry in the same amount, the bivalent strong acid tend to be more effective in preventing aggregation of cerium oxide particles than the monovalent strong acid.

The amount of the polycarboxylic acid needed for obtaining high smoothness tend to be higher when the pH of the polishing slurry is higher, and the amount of the strong acid needed tends to increase when the content of the polycarboxylic acid is lower. Thus, a higher pH of the polishing slurry leads to increase in the amount of the polycarboxylic acid and the strong acid added for obtaining the same smoothness, which in turn leads to deterioration in the dispersion stability of cerium oxide particles and to increase of the particle diameter over time, but the polishing slurry still has the effect of the present invention to reduce the fluctuation in film thickness due to difference in pattern density.

The polishing slurry according to the present invention may contain another water-soluble polymer. The another water-soluble polymer is not particularly limited, and examples thereof include polysaccharides such as alginic acid, pectin acid, carboxymethylcellulose, agar, curdlan and pullulan; polycarboxylic acids and the salts such as polyaspartic acid, polyglutamic acid, polylysine, polymalic acid, polyamic acid, polymaleic acid, polyitaconic acid, polyfumaric acid, ammonium polyamate salt, sodium polyamate salt and polyglyoxylic acid, and the salts thereof; and vinyl polymers such as polyvinylalcohol, polyvinylpyrrolidone, and polyacrolein. The weight-average molecular weight of the water-soluble polymer is preferably 500 or more, and the blending amount thereof is preferably in the range of 0.01 weight part or more and 5 weight parts or less with respect to 100 weight parts of the CMP polishing slurry.

The CMP polishing slurry according to the present invention is used for polishing, after it is adjusted to a desirable pH.

The pH adjuster for use is not particularly limited, but ammonia water is used more favorably than alkali metals when the polishing slurry is used for semiconductor polishing.

The CMP polishing slurry is obtained by preparing an aqueous solution containing a strong acid, an unneutralized polycarboxylic acid and water, adjusting the pH of the aqueous solution with a pH adjuster such as ammonia water, and then, adding cerium oxide particles and others. If the amount of ammonia needed to adjust the solution to a particular pH is known previously, the strong acid at a particular concentration may be added after addition of ammonia.

An ammonium polycarboxylate salt having a neutralization ratio of 100% or less, i.e., a polycarboxylic acid partially or completely neutralized with a pH adjuster, may be used as the pH adjuster, replacing the polycarboxylate pH adjuster. In such a case, the ammonium polycarboxylate salt may be first mixed with water and then with a strong acid in a predetermined concentration range for pH adjustment.

However when an ammonium polycarboxylate salt excessively neutralized with ammonia (over a neutralization ratio of 100%) is used, an acid component may be needed for neutralization of the excessive ammonia component during pH adjustment to a desirable value, which may result in deterioration in dispersion stability of cerium oxide particles and enlargement of the cerium oxide particle diameter during redispersion.

The neutralization ratio of the ammonium polycarboxylate is determined by the following method: The polishing slurry is subjected to solid-liquid separation in a semimicro-sample high-speed centrifugal separator CF-15R equipped with an angle rotor manufactured by Hitachi Koki Co., Ltd., at 15,000 rpm for 30 minutes. The concentration of the polycarboxylic acid is determined by measuring the organic carbon in the supernatant liquid in a total organic carbon analyzer TOC-5000 manufactured by Shimadzu Corporation. Separately, the neutralization ratio of the polycarboxylic acid is determined by measuring the ammonium ion concentration in a capillary electrophoretic system CAPI-3300 manufactured by Otsuka Electronics Co., Ltd., at an electrophoretic voltage of 30 kV, by using 10 mM imidazole as an electrophoretic solution, a hydrodynamic injection method (25 mm, 90 sec), and indirect UV (210 mm) for detection.

The pH of the CMP polishing slurry is preferably 4.0 or more and 7.5 or less, more preferably 4.5 or more and 5.5 or less. An excessively lower pH leads to deterioration in the chemical polishing action of the polishing slurry itself and also in polishing speed, to less easier dissociation of the dispersant, and thus to deterioration in dispersion stability of cerium oxide particles. On the other hand, an excessively high pH leads to deterioration in surface smoothness and thus, to increase in the amount of the polycarboxylic acid or the strong acid needed for obtaining high smoothness and also of ammonia added, consequently to deterioration in dispersion stability of the cerium oxide particles and enlargement of the cerium oxide particle diameter.

The pH of the CMP polishing slurry according to the present invention was determined by using a pH meter (for example, Model PH81, manufactured by Yokogawa Electric Corporation), and after two-point calibration with a standard buffer solution (a phthalate pH buffer solution, pH: 4.21 (25° C.) and a neutral phosphate pH buffer solution, pH 6.86 (25° C.)), an electrode was immersed in the CMP polishing slurry, and the pH stabilized after 2 minutes or longer was determined.

The polishing slurry according to the present invention may be stored as a two-liquid CMP polishing slurry consisting of a cerium oxide slurry of cerium oxide particles, a dispersant and water, and a supplementary solution containing a polycarboxylic acid, a strong acid and water that is pH-adjusted as needed with a pH adjuster such as ammonia, or as a single-liquid polishing slurry containing cerium oxide particles, a dispersant, a polycarboxylic acid, a strong acid and water, as well as a pH adjuster as needed. When the polishing slurry is stored as a two-liquid polishing slurry consisting of a cerium oxide slurry and a supplementary solution, it is possible to adjust the smoothening characteristics and polishing speed thereof by arbitrarily modifying the blending rate of these two solutions. During polishing with the two-liquid polishing slurry, the supplementary solution and the cerium oxide slurry are fed to a polishing table as they are supplied separately from different pipes and mixed immediately before a supply pipe outlet where these pipes are connected. Alternatively, it is also possible to supply the two-liquid polishing slurry as a single-liquid polishing slurry through a single pipe, by mixing the cerium oxide slurry and the supplementary solution stored as a two-liquid polishing slurry with deionized water previously at a predetermined blending rate. It is also possible to adjust the polishing characteristics of the adhesive by adding deionized water as needed to the cerium oxide slurry and the supplementary solution during mixing thereof in piping as described.

The polishing method according to the present invention is characterized by pressing a substrate having a film to be polished onto a polishing cloth of a polishing table, and polishing the film to be polished by moving the substrate and the polishing table relatively to each other while the CMP polishing slurry according to the present invention is supplied to the space between the film to be polished and the polishing cloth.

Examples of the substrates include substrates for semiconductor device production, for example, substrates having an inorganic insulation layer formed on a semiconductor substrate such as a semiconductor substrate having a circuit device and a wiring pattern formed thereon and a semiconductor substrate having a circuit device formed thereon. Examples of the films to be polished include the inorganic insulation layers described above including a silicon oxide film layer, a silicon nitride layer and a silicon oxide film layer, and the like. Surface irregularity of the silicon oxide film layer is eliminated by polishing the silicon oxide or nitride film layer formed on the semiconductor substrate with the CMP polishing slurry above, and the semiconductor substrate is smoothened over the entire surface. The substrate can also be used for shallow trench isolation. For use in shallow trench isolation, the ratio of the silicon-oxide-film polishing speed to the silicon-nitride-film polishing speed, i.e., (silicon-oxide-film polishing speed)/(silicon nitride film polishing speed), is preferably 10 or more. The difference between the silicon-oxide-film polishing speed and the silicon nitride film polishing speed is small at a ratio of less than 10, and it is difficult to stop polishing at a predetermined position during shallow trench isolation. The polishing speed of the silicon nitride film becomes far smaller at a ratio of 10 or more, and thus, it is possible to stop polishing easily and thus such a high ratio is more favorable for shallow trench isolation. The substrate is preferably protected from scratching during polishing for use in shallow trench isolation.

Hereinafter, the polishing method will be described, taking a semiconductor substrate carrying an inorganic insulation layer formed thereon as an example.

For example, in the polishing method according to the present invention, a common polishing machine having: a polishing table with a removable polishing cloth (pad) connected, for example, to a rotational frequency-variable motor; and a holder capable of holding a substrate carrying a film to be polished such as a semiconductor substrate may be used as the polishing machine. Examples of the polishing machines include a polishing machine, Model No. EPO-111 manufactured by Ebara Corporation, and the like. The polishing cloth is not particularly limited, and examples thereof include general nonwoven fabrics, foamed polyurethane, porous fluoroplastics, and the like. The polishing cloth preferably has trenches for holding the CMP polishing slurry processed thereon. The polishing condition is not particularly limited, but the rotational velocity of the polishing table is preferably lower at 200 rpm or lower for prevention of separation of the semiconductor substrate, and the pressure applied onto the semiconductor substrate (processing load) is preferably 100 kPa or less for prevention of scratching after polishing. It is preferable to supply the CMP polishing slurry continuously, for example, by a pump to the polishing cloth during polishing. The feed rate is not particularly limited, but the surface of the polishing cloth is preferably, always covered with the CMP polishing slurry.

The semiconductor substrate after polishing is preferably washed thoroughly with running water and dried, as the water droplets on the semiconductor substrate are removed, for example, by a spin dryer. It is thus possible to eliminate surface irregularity and form a smooth surface over the entire area of the semiconductor substrate by polishing the inorganic insulation film, which is the film to be polished, with the polishing slurry. After the surface-smoothened shallow trenches are formed, aluminum wiring is formed on the silicon oxide inorganic insulation film layer; and then, an silicon oxide inorganic insulation film is formed again between and on the wirings by a method described below and polished similarly with the CMP polishing slurry above, to give a smoothened surface. It is possible to produce a semiconductor substrate having a desired number of layers by repeating the steps above several times.

For global smoothening of an irregular-surfaced film to be polished (silicon oxide film), convex regions thereon should be polished selectively. When the polishing slurry containing the water-soluble polymer according to the invention is used, a protection film is formed on the surface of the cerium oxide particles and the film to be polished. Thus, the film to be polished in concave regions having a smaller effective polishing load is protected, but the film to be polished on the convex regions having a greater effective polishing load is polished selectively by elimination of the protection of films. In this way, it is possible to perform global smoothening, independently of the pattern on the polishing surface.

The inorganic insulation film, to which the CMP polishing slurry according to the present invention is used, is produced, for example, by low-pressure CVD, plasma CVD, or the like. In preparing the silicon oxide film by the low-pressure CVD, monosilane SiH₄ is used as a Si source and oxygen O₂ is used as an oxygen source. The silicon oxide film is obtained in the SiH₄—O₂ oxidation reaction at a temperature of 400° C. or lower. The silicon oxide film is heat-treated as needed after CVD at a temperature of 1,000° C. or lower. When phosphorus P is doped for surface smoothening by high temperature reflow, use of a SiH₄—O₂—PH₃ reaction gas is preferable. The plasma CVD method has an advantage that the chemical reaction, which demands high temperature under normal thermal equilibrium, can be carried out at low temperature. The plasma generation methods include two methods: a capacitively coupled method and an inductively coupled method. Examples of the reaction gases include a SiH₄—N₂O gas containing SiH₄ as the Si source and N₂O as the oxygen source; and a TEOS-O gas (TEOS-plasma CVD method) containing tetraethoxysilane (TEOS) as the Si source. The substrate temperature is preferably 250° C. to 400° C., and the reaction pressure is preferably in the range of 67 to 400 Pa. Thus, the silicon oxide film for used in the present invention may be doped with an element such as phosphorus or boron. Similarly, the silicon nitride film is formed by use of dichlorosilane (SiH₂Cl₂) as the Si source and ammonia (NE₃) as the nitrogen source. The silicon oxide film is obtained at a high temperature of 900° C. in the SiH₂Cl₂—NH₃ oxidation reaction. The reaction gas used in forming a silicon nitride film by the plasma CVD method is a SiH₄—NH₃ gas containing SiH₄ as the Si source and NH₃ as the nitrogen source. The support temperature is preferably 300° C. to 400° C.

The CMP polishing slurry and the polishing method according to the present invention can be applied not only to the silicon oxide film formed on a semiconductor substrate but also can be used in the production processes for various semiconductor devices. For example, it can be used in polishing: silicon oxide films formed on a wiring board having a particular wiring; inorganic insulation films such as of glass or silicon nitride; films mainly containing polysilicon, Al, Cu, Ti, TiN, W, Ta, TaN, or the like; optical glasses such as photomask, lens, and prism; inorganic conductive films such as of ITO film; optical integrated circuit, photoswitching element, and optical waveguides such as of glass or a crystalline material; end face of optical fiber; optical single crystals such as scintillator; solid state laser single crystals; blue laser LED sapphire substrates; semiconductor single crystals such as of SiC, GaP, and GaAs; glass plates for magnetic disk; magnetism heads, and the like.

### EXAMPLE

### Example 1 to Example 6 and Comparative Example 1 to Comparative Example 5

(Preparation of Cerium Oxide Particle and Cerium Oxide Slurry)

60 kg of cerium carbonate hydrate was placed in an alumina container and calcined at 830° C. for 2 hours in air, to give 30 kg of a yellow white powder. Analysis of the powder by X-ray diffraction confirmed that the product was cerium oxide. The diameter of the calcined powder particles was 30 to 100 μm. Then, 30 kg of the cerium oxide particle powder was dry-pulverized in a jet mill. The specific surface area of the polycrystalline material, as determined by a BET method, was 9 m²/g.

20 kg of the cerium oxide powder thus obtained and 79.750 kg of deionized water were mixed; 500 g of a commercially available aqueous ammonium polyacrylate solution (weight-average molecular weight: 8,000, weight 40%) was added as a dispersant; and the mixture was ultrasonicated while stirred, to give a cerium oxide dispersion. The ultrasonic wave frequency was 400 kHz, and the dispersion period was 20 minutes. Then, 5 kg of the cerium oxide dispersion was placed, left still, and subjected to sedimentation classification in a 10-L container. After classification for 200 hours, the supernatant dispersion at a height of 110 mm or more from the container bottom was withdrawn with a pump. The supernatant cerium oxide dispersion obtained was diluted with deionized water to a solid matter concentration of 5 weight %, to give a cerium oxide slurry. The slurry was diluted to a suitable concentration for measurement of the average particle diameter of the particles in the cerium oxide slurry, and the average particle diameter D50, as determined by using a laser-diffraction particle size distribution analyzer Master Sizer Microplus (trade name, manufactured by Malvern) at a refractive index of 1.93 and an absorption of 0, was 170 nm. The amount of impurity ions (Na, K, Fe, Al, Zr, Cu, Si, and Ti), as determined by an atomic absorption photometer (Model No. AA-670G, manufactured by Shimadzu Corporation), was 1 ppm or less.

(Preparation of Supplementary Solution Containing a Polycarboxylic Acid)

In Example 1, 40.5 g of a commercially available aqueous polyacrylic acid solution (weight-average molecular weight: 5,000) (40 weight %) and 4,600 g of deionized water were mixed; 1.25 g of a sulfuric acid (96 weight %) was added so that the sulfuric acid concentration in 6,000 g of the polishing slurry blended with a cerium oxide (ceria) slurry became 200 ppm; the mixture was adjusted to pH 4.8 with ammonia water (25 weight %); and finally, deionized water was added to make the aqueous solution in a final amount of 4,800 g, to give a supplementary solution.

In Example 2, 40.5 g of the commercially available aqueous polyacrylic acid solution (40 weight %) used in Example 1 and 4,600 g of deionized water were mixed; 1.88 g of a sulfuric acid (96 weight %) was added so that the sulfuric acid concentration in 6,000 g of the polishing slurry blended with a ceria slurry became 300 ppm; the mixture was adjusted to pH 4.8 with ammonia water (25 weight %); and finally, deionized water was added to the aqueous solution to a final amount of 4,800 g.

In Example 3, 40.5 g of the commercially available aqueous polyacrylic acid solution (40 weight %) used in Example 1 and 4,600 g of deionized water were mixed; 3.75 g of a sulfuric acid (96 weight %) was added so that the sulfuric acid concentration in 6,000 g of the polishing slurry after blending with a ceria slurry became 600 ppm; the mixture was adjusted to pH 4.8 with ammonia water (25 weight %); and finally, deionized water was added to the aqueous solution to a final amount of 4,800 g.

In Example 4, 40.5 g of the commercially available aqueous polyacrylic acid solution (40 weight %) used in Example 1 and 4,600 g of deionized water were mixed; 5.63 g of a sulfuric acid (96 weight %) was added so that the sulfuric acid concentration in 6,000 g of the polishing slurry after blending with a ceria slurry became 900 ppm; the mixture was adjusted to pH 4.8 with ammonia water (25 weight %); and finally, deionized water was added to the aqueous solution to a final amount of 4,800 g.

In Example 5, 40.5 g of the commercially available aqueous polyacrylic acid solution (40 weights %) used in Example 1 and 4,600 g of deionized water were mixed; 5.0 g of a hydrochloric acid (36 weight %) was added so that the hydrochloric acid concentration in 6,000 g of the polishing slurry after blending with a ceria slurry became 300 ppm; the mixture was adjusted to pH 4.8 with ammonia water (25 weight %); and finally, deionized water was added to the aqueous solution to a final amount of 4,800 g.

In Example 6, 40.5 g of the commercially available aqueous polyacrylic acid solution (40 weight %) used in Example 1 and 4,600 g of deionized water were mixed; 2.58 g of a nitric acid (70 weight %) was added so that the nitric acid concentration in 6,000 g of the polishing slurry after blending with a ceria slurry became 300 ppm; the mixture was adjusted to pH 4.8 with ammonia water (25 weight %); and finally, deionized water was added to the aqueous solution to a final amount of 4,800 g.

In Comparative Example 1, 40.5 g of the commercially available aqueous polyacrylic acid solution (weight-average molecular weight: 5,000) (40 weight %) used in Example 1 and 4,600 g of deionized water were mixed; the mixture was adjusted to pH 4.8 with ammonia water (25 weight %) without addition of a sulfuric acid; and finally, deionized water was added to the aqueous solution to a final amount of 4,800 g.

In Comparative Example 2, 40.5 g of the commercially available aqueous polyacrylic acid solution (40 weight %) used in Comparative Example 1 and 4,600 g of deionized water were mixed; 1.8 g of a malic acid was added so that the malic acid concentration in 6,000 g of the polishing slurry blended with a ceria slurry became 300 ppm; the mixture was adjusted to pH 4.8 with ammonia water (25 weight %); and finally, deionized water was added to the aqueous solution to a final amount of 4,800 g.

In Comparative Example 3, 40.5 g of the commercially available aqueous polyacrylic acid solution (40 weight %) used in Comparative Example 1 and 4,600 g of deionized water were mixed; 1.8 g of a succinic acid was added so that the succinic acid concentration in 6,000 g of the polishing slurry after blending with a ceria slurry became 300 ppm; the mixture was adjusted to pH 4.8 with ammonia water (25 weight %); and finally, deionized water was added to the aqueous solution to a final amount of 4,800 g.

In Comparative Example 4, 40.5 g of the commercially available aqueous polyacrylic acid solution (40 weight %) used in Comparative Example 1 and 4,600 g of deionized water were mixed; 1.8 g of an acetic acid (99.9 weight %) was added so that the acetic acid concentration in 6,000 g of the polishing slurry after blending with ceria slurry became 300 ppm; the mixture was adjusted to pH 4.8 with ammonia water (25 weight %); and finally, deionized water was added to the aqueous solution to a final amount of 4,800 g.

In Comparative Example 5, 40.5 g of the commercially available aqueous polyacrylic acid solution (40 weight %) used in Comparative Example 1 and 4,600 g of deionized water were mixed; 7.5 g of a sulfuric acid (96 weight %) was added so that the sulfuric acid concentration in 6,000 g of the polishing slurry after blending with a ceria slurry became 1,200 ppm; the mixture was adjusted to pH 4.8 with ammonia water (25 weight %); and finally, deionized water was added to the aqueous solution to a final amount of 4,800 g.

The weight-average molecular weight of the commercial polyacrylic acid above, as determined with a HPLC pump (Model No. L-7100, manufactured by Hitachi, Ltd.) equipped with a differential refractometer (Model No. L-3300, manufactured by Hitachi, Ltd.) and a GPC column (Model No. W550, manufactured by Hitachi Chemical Co., Ltd.) connected thereto by using 0.3 M NaCl as a mobile phase, was 5,000 as polyethylene glycol.

(Preparation of CMP Polishing Slurry)

4,800 g of each of the supplementary solutions obtained in Examples 1 to 6 and Comparative Examples 1 to 5 and 1,200 g of the cerium oxide slurry (solid matter: 5 weight %) were mixed, to give 6,000 g of a cerium oxide-based CMP polishing slurry (solid matter: 1.0 weights). The pH of the polishing slurry was 5.0. Analysis of the particles in the polishing slurry in a laser diffraction particle size distribution analyzer after it is diluted to a suitable concentration showed that the average diameter D50 of each of the particles obtained in Examples 1 to 6 and Comparative Examples 1 to 4 was 170 nm and that in Comparative Example 5 was 180 nm.

The particle diameter D50 of the particles obtained in Examples 1 to 6 and Comparative Examples 1 to 4 after storage for three months remained 170 nm, while that of Comparative Example 5 was 200 nm, showing slight increase in the cerium oxide particle diameter.

The concentrations of sulfate, hydrochloride, and nitrate ions in the polishing slurry were determined by analyzing the supernatant liquid obtained by centrifugation of each of the CMP polishing slurries obtained Examples 1 to 6 and Comparative Examples 1 to 5 in a capillary electrophoresis analyzer (Model No. CAPI-3300, manufactured by Otsuka Electronics Co., Ltd.). The electrophoretic voltage was −30 kV; the buffer and the sample were injected by the hydrodynamic injection method (height: 25 mm), and the injection period was 30 seconds. A calibration curve prepared by three strong acid ion samples at concentrations 300, 600, and 1,000 ppm was used for calculation of the concentration. As a result, the polishing slurries obtained in Examples 1 to 6 and Comparative Example 5 were found to contain a strong acid ion at a predetermined concentration. The polishing slurries obtained in Comparative Examples 1 to 4 had a strong acid ion concentration of 10 ppm or less.

(Polishing of Insulation Film Layer)

Among test wafers for evaluating shallow-trench-isolation (STI) insulation film CMP, a wafer (φ200 mm) having a PE-TEOS silicon oxide film (SiO₂) with a film thickness of 1,000 nm formed on a Si substrate and a water (φ200 mm) having a silicon nitride film (Si₃N₄) with a film thickness of 200 nm formed on a Si substrate were used as blanket wafers without pattern.

In addition, a 864 wafer (φ200 mm) manufactured by International SEMATECH was used as the a pattern wafer carrying a STI simulated pattern. The silicon oxide (SiO₂) insulation film embedded therein was a film with a film thickness of 600 nm formed by a high density plasma (HDP) method. The film thickness of the Si₃N₄ film was 150 nm; the film thickness of the Si₂O film in the convex region was 600 nm and that in the concave region were 600 nm; the depth in the concave region was 480 nm: a trench depth of 330 nm and a Si₃N₄ film thickness of 150 nm.

For evaluation of pattern density dependency, used were dies of 4×4 mm block, of which the widths of the line (convex region) and the space (concave region) were 100 μm pitch, having a convex pattern density of 10% to 90%, 0% (4×4 mm concave region), and 100% (4×4 mm convex region) respectively. The lines and spaces form a STI simulated pattern consisting of convex Si₃N₄-masked active areas and dent groove-formed trench areas aligned alternately. The 100 μm pitch above means that the total width of the line and space areas is 100 μm. A convex pattern density of 10% means, for example, a pattern in which a convex region of 10 μm in width and a concave region of 90 μm in width are aligned alternately, and a convex pattern density 90% means a pattern in which a convex region of 90 μm in width and a concave region of 10 μm in width are aligned alternately.

The test wafer was placed on a holder carrying an absorption pad for fixing a substrate in a polishing machine (trade name: Mirra, manufactured by Applied Materials) while a porous urethane-resin polishing pad IC1000 (K groove) manufactured by Rodel was fixed onto a φ480 mm polishing table. The holder was placed on the pad with the wafer's insulation film face downward, and the pressures to the membrane, retainer ring, and inner tube were respectively set to 3.0 psi, 3.5 psi, and 3.0 psi (20.6 kPa, 24.0 kPa, and 20.6 kPa) as processing loads. The CMP polishing slurry prepared above was applied on the polishing table dropwise at a flow rate of 200 mL/minute, and the polishing table and the wafer were rotated respectively at frequencies of 98 rpm and 78 rpm, to polish the test wafer for evaluation of STI insulating film CMP.

The blanket wafer was polished for 60 seconds. The period of polishing the pattern wafer was a period needed for exposing the Si₃N₄ film almost entirely in the 100% (4×4 convex region) patterned area, and the polishing end point was determined by monitoring the torque current of the polishing table. When there was the SiO₂ film remaining on the Si₃N₄ film in the convex pattern region to a thickness of 10 nm or more, the wafer was polished additionally as needed.

The wafer after polishing washed thoroughly with purified water and then dried. The thickness of the residual insulation film in concave and convex regions or the residual Si₃N₄ film was determined by using an optical interference thickness meter (trade name: Nanospec AFT-5100, manufactured by Nanometrics Inc.). In addition, the difference in level between the convex region and the concave region after polishing was determined by using a level difference meter Dektak V200-Si manufactured by Veeco. The results are summarized in Tables 1 and 2.

### Examples 7 to 9

In Examples 7 to 9 and Comparative Example 6, a polycarboxylic acid was first prepared.

(Preparation of Cerium Oxide Particles and Cerium Oxide Slurry)

They were prepared in the same manner as in Examples 1 to 6.

(Preparation of Polycarboxylic Acid)

In Example 7, 960 g of deionized water was placed in a 3-liter preparative flask and heated to 90° C. while stirred under nitrogen gas atmosphere, and a solution of 547 g of acrylic acid and 54 g of ammonium persulfate dissolved in 500 g of deionized water was added into the flask over a period of 2 hours. The mixture was kept at 90° C. for 5 hours and cooled, to give an aqueous polyacrylic acid solution. The content of the nonvolatile matter therein was found to be 25 weight %.

The weight-average molecular weight of the polyacrylic acid thus obtained, as determined in the same manner as in the molecular weight measurement of the commercial polyacrylic acid used in Example 1, was 5,000 (as polyethylene glycol).

In Example 8, 960 g of deionized water was placed in a 3-liter preparative flask and heated to 90° C. while stirred under nitrogen gas atmosphere, and a solution of 497 g of acrylic acid and 103 g of 2,2′-azobis[2-(2-imidazolin-2-yl)propane]bisulfate dihydrate salt dissolved in 500 g of deionized water was added into the flask over a period of 2 hours. The mixture was kept at 90° C. for 3 hours and cooled, to give a polyacrylic acid solution. The content of the nonvolatile matter therein was found to be 25 weight %. The weight-average molecular weight of the polyacrylic acid thus obtained, as determined in the same manner as in Example 7, was 3,200 (as polyethylene glycol).

In Example 9, 960 g of deionized water was placed in a 3-liter preparative flask and heated to 90° C. while stirred under nitrogen gas atmosphere, and a solution of 256 g of methacrylic acid, 255 g of acrylic acid, and 89 g of 2,2′-azobis[2-(2-imidazolin-2-yl)propane]bisulfate dihydrate salt dissolved in 500 g of deionized water was added into the flask over a period of 2 hours. The mixture was kept at 90° C. for 3 hours and cooled, to give a water-soluble polymer solution (aqueous polyacrylic acid-methacrylic acid copolymer solution). The content of the nonvolatile matter therein was found to be 25 weight %. The weight-average molecular weight of the polyacrylic acid thus obtained, as determined in the same manner as in Example 7, was 7,500 (as polyethylene glycol).

In Comparative Example 6, 960 g of deionized water was placed in a 3-liter preparative flask and heated to 90° C. while stirred under nitrogen gas atmosphere, and a solution of 497 g of acrylic acid and 53 g of 2,2′-azobis[2-(2-imidazolin-2-yl)propane] dissolved in 500 g of methanol was added into the flask over a period of 2 hours. The mixture was kept at 90° C. for 3 hours and cooled, to give a polyacrylic acid solution. The content of the nonvolatile matter therein was found to be 25 weight %. The weight-average molecular weight of the polyacrylic acid thus obtained, as determined in the same manner as in Example 7, was 5,000 (as polyethylene glycol).

Each of the aqueous polycarboxylate solutions obtained in Examples 7 to 8 and Comparative Example 6 and the aqueous polyacrylic acid-methacrylic acid copolymer solution obtained in Example 9 were diluted 100 times with deionized water. The sulfate ion concentration in the diluted solution was determined by using the same apparatus as that for analyzing the supernatant liquid of the CMP polishing slurries in Examples 1 to 6 under the same condition. A calibration curve prepared by three sulfate ion samples at concentrations 300, 600, and 1,000 ppm was used for calculation of the concentration. As a result, the polymers of Examples 7 and 9 were found to contain the sulfate ion in an amount of approximately 8 weight %; the polymer in Example 8 was found to contain the sulfate ion in an amount of approximately 9 weight %; and the polymer in Comparative Example 6 was found to contain the sulfate ion in an amount of less than 1 weight %.

(Preparation of Supplementary Solution and CMP Polishing Slurry)

In Examples 7 and 8, 64.8 g of the aqueous polyacrylic acid solution thus obtained (25 weight %) and 4,600 g of deionized water were mixed; the mixture was adjusted to pH 4.8 with ammonia water (25 weight %); and finally, deionized water was added to bring the aqueous solution weight to 4,800 g, to give a supplementary solution.

In Example 9, 64.8 g of the aqueous polyacrylic acid-methacrylic acid copolymer solution obtained above (25 weight %) and 4,600 g of deionized water were mixed; the mixture was adjusted to pH 4.8 with ammonia water (25 weight %); and finally, deionized water was added to the aqueous solution to a final amount of 4,800 g.

In Comparative Example 6, 64.8 g of the aqueous polyacrylic acid solution thus obtained (25 weight %) and 4,600 g of deionized water were mixed; the mixture was adjusted to pH 4.8 with ammonia water (25 weight %); and finally, deionized water was added to the aqueous solution to a final amount of 4,800 g.

4,800 g of each of the supplementary solutions prepared in Examples 7 to 9 and Comparative Example 6 and 1,200 g of the cerium oxide slurry (solid matter: 5 weight %) were mixed, to give 6,000 g of a cerium oxide-based CMP polishing slurry (solid matter: 1.0 weight %). The polishing slurry pH was 5.0; and analysis of the particles in the polishing slurry in a laser diffraction particle size distribution analyzer as it is diluted to a suitable concentration showed that the polishing slurries in Examples 7 to 9 and Comparative Example 6 had a constant average particle diameter D50 of 170 nm. The average particle diameters D50 thereof after storage for three months were also consistent at 170 nm.

The sulfate ion concentration in the supernatant liquid obtained by centrifugation of each of the CMP polishing slurries thus obtained was determined by using the same apparatus as that for analyzing the supernatant liquid of the CMP polishing slurries in Examples 1 to 6 under the same condition. A calibration curve prepared by three sulfate ion samples at concentrations 300, 600, and 1,000 ppm was used for calculation of the concentration. As a result, the polishing slurries of Examples 7, 8 and 9 were found to have sulfate ion concentrations respectively of 240, 270 and 230 ppm. The polishing slurry of Comparative Example 6 had a sulfate ion concentration of 10 ppm or less.

(Polishing of Insulation Film Layer)

The insulation film layer was polished in the same manner as in Examples 1 to 6. The measurements results are summarized in Table 3.

### Examples 10 to 13 and Comparative Examples 7 to 9

The pH of the polishing slurry was changed in studies of the polishing slurries obtained in Examples 10 and 11 and Comparative Examples 7 and 8. A strong acid salt was used in the study of the polishing slurry obtained in Example 12. In the study of the polishing slurries obtained in Example 13 and Comparative Example 9, an ammonium polyacrylate salt was used and the pH of the polishing slurry was adjusted with a strong acid.

(Preparation of Cerium Oxide Particle and Cerium Oxide Slurry)

They were prepared in the same manner as in Examples 1 to 6.

(Preparation of Supplementary Solution)

In Example 10, 22.5 g of a commercially available aqueous polyacrylic acid solution (weight-average molecular weight: 5000) (40 weight %) and 4,600 g of deionized water were mixed; 1.88 g of a sulfuric acid (96 weight %) was added thereto so that the concentration of the sulfuric acid in 6,000 g of the polishing slurry after addition of a ceria slurry became 300 ppm; the mixture was adjusted to pH 4.0 with ammonia water (25 weight %); and finally, deionized water was added to the aqueous solution to a final amount of 4,800 g.

In Example 11, 150 g of the commercially available aqueous polyacrylic acid solution (40 weight %) used in Example 10 and 4,500 g of deionized water were mixed; 6.25 g of a sulfuric acid (96 weight %) was added thereto so that the concentration of the sulfuric acid in 6,000 g of the polishing slurry after addition of a ceria slurry became 1000 ppm; the mixture was adjusted to pH 6.8 with ammonia water (25 weight %); and finally, deionized water was added to the aqueous solution to a final amount of 4,800 g.

In Example 12, 40.5 g of the commercially available aqueous polyacrylic acid solution (40 weight %) used in Example 10 and 4,600 g of deionized water were mixed; 2.44 g of ammonium sulfate was added thereto so that the concentration of the sulfuric acid in 6,000 g of the polishing slurry after addition of a ceria slurry became 300 ppm; the mixture was adjusted to pH 4.8 with ammonia water (25 weight %); and finally, deionized water was added to the aqueous solution to a final amount of 4,800 g.

In Example 13, 27.0 g of a commercially available aqueous ammonium polyacrylate solution having a neutralization ratio of approximately 100% (weight-average molecular weight: 8,000) (40 weight %, pH 6.1) and 4,600 g of deionized water were mixed; the mixture was adjusted to pH 4.6 by addition of a nitric acid (70 weight %); and finally, deionized water was added to the aqueous solution to a final amount of 4,800 g.

In Comparative Example 7, 22.5 g of the commercially available aqueous polyacrylic acid solution (40 weight %) used in Example 10 and 4,600 g of deionized water were mixed; 1.876 g of a sulfuric acid (96 weight %) was added thereto so that the concentration of the sulfuric acid in 6,000 g of the polishing slurry after addition of a ceria slurry became 300 ppm; the mixture was adjusted to pH 3.6 with ammonia water (25 weight %); and finally, deionized water was added to the aqueous solution to a final amount of 4,800 g.

In Comparative Example 8, 225 g of the commercially available aqueous polyacrylic acid solution (40 weight %) used in Example 10 and 4,500 g of deionized water were mixed; 6.25 g of a sulfuric acid (96 weight %) was added thereto so that the concentration of the sulfuric acid in 6,000 g of the polishing slurry after addition of a ceria slurry became 1,000 ppm; the mixture was adjusted to pH7.5 with ammonia water (25 weight %); and finally, deionized water was added to the aqueous solution to a final amount of 4,800 g.

In Comparative Example 9, 27.0 g of a commercially available aqueous ammonium polyacrylate solution excessively neutralized (having a neutralization ratio of 100% or more, weight-average molecular weight: 8,000) (40 weight %, pH9.1) and 4,600 g of deionized water were mixed; the mixture was adjusted to pH 4.6 by addition of a nitric acid (70 weight %); and finally, deionized water was added to the aqueous solution to a final amount of 4,800 g.

The neutralization ratio of the ammonium polyacrylate was determined by the following method: The polishing slurry was subjected to solid-liquid separation in a small-sample high-speed centrifugal separator CF-15R equipped with an angle rotor manufactured by Hitachi Koki Co., Ltd., at 15,000 rpm for 30 minutes. The concentration of the polyacrylic acid was determined by measuring the organic carbon in the supernatant liquid in a total organic carbon analyzer TOC-5000 manufactured by Shimadzu Corporation. The neutralization ratio of the polyacrylic acid was determined by measuring the ammonium ion concentration, in a capillary electrophoretic system CAPI-3300 manufactured by Otsuka Electronics Co., Ltd., at an electrophoretic voltage of 30 kV by using 10 mM imidazole as an electrophoretic solution, hydrodynamic injection method (25 mm, 90 sec) for sample injection, and indirect UV (210 mm) for detection.

(Preparation of CMP Polishing Slurry)

4,800 g of each of the supplementary solutions obtained in Examples 10 to 13 and Comparative Examples 7 to 9 and 1,200 g of the cerium oxide slurry (solid matter: 5 weight %) were mixed, to give 6,000 g of a cerium oxide-based CMP polishing slurry (solid matter: 1.0 weight %). The pH's of the polishing slurries in Examples 10 to 13 and Comparative Examples 7 to 9 were respectively 4.2, 7.0, 5.0, 4.8, 3.9, 7.6, and 4.8. The average particle diameter D50 of the particles in the polishing slurries in Examples 10 to 13, as determined in a laser diffraction particle size distribution analyzer after dilution to a suitable concentration, was 170 nm, and that in Comparative Examples 7 to 9 was 180 nm.

The particle diameter D50 of the particles in Examples 10 to 11 after storage for three months was 180 nm, and that in Examples 12 and 13 remained to be 170 nm. D50 became 200 nm in Comparative Examples 7 to 9, indicating gradual enlargement of the cerium oxide particle diameter over time.

The weight-average molecular weight of the commercial polyacrylic acid used in Examples 10 to 12 and Comparative Examples 7 to 8, as determined under a condition similar to that for determining the molecular weight of the commercial polyacrylic acid used in Example 1, was 5,000 as polyethylene glycol.

The sulfate ion concentration and nitrate ion concentration of the supernatant liquid obtained by centrifuging each CMP polishing slurry obtained were determined by using the same apparatus as that for analyzing the supernatant liquids of the CMP polishing slurries obtained in Examples 1 to 6 under the same condition. A calibration curve prepared by three strong acid ion samples at concentrations 300, 600, and 1000 ppm was used for calculation of the concentration. As a result, the polishing slurries obtained in Examples 10 to 12 and Comparative Examples 7 to 8 were found to have sulfate ions at a predetermined concentration. The nitrate concentration in the polishing slurries obtained in Example 13 and Comparative Example 9 were respectively found to be 520 ppm and 1,200 ppm.

(Polishing of Insulation Film Layer)

The insulation film layer was polished in the same manner as in Examples 1 to 6. The measurement results are summarized in Table 4.

TABLE 1

| | Example | | | | | |
|---|---|---|---|---|---|---|
| | No. | | | | | |
| | 1 | 2 | 3 | 4 | 5 | 6 |
| Polishing powder | 1 | 1 | 1 | 1 | 1 | 1 |
| concentration | | | | | | |
| (wt. %) | | | | | | |
| Polyacrylic acid | 0.27 | 0.27 | 0.27 | 0.27 | 0.27 | 0.27 |
| concentration | | | | | | |
| (wt. %) | | | | | | |
| Acid (pKa) | Sulfuric | Sulfuric | Sulfuric | Sulfuric | Hydrochloric | Nitric |
| | acid | acid | acid | acid | acid | Acid |
| | (<0) | (<0) | (<0) | (<0) | (−2) | (−1.8) |
| Acid concentration* | 200 | 300 | 600 | 900 | 300 | 300 |
| (ppm) | | | | | | |
| PTEOS polishing speed | 275 | 265 | 210 | 112 | 250 | 273 |
| (nm/min) | | | | | | |
| Si₃N₄ polishing | 7 | 7 | 8 | 9 | 8 | 7 |
| speed (nm/min) | | | | | | |
| Pattern polishing | 185 | 187 | 220 | 285 | 195 | 181 |
| period (sec) | | | | | | |
| Convex-region film | 123 | 130 | 135 | 140 | 131 | 125 |
| thickness 10% (nm) | | | | | | |
| Convex-region film | 149 | 150 | 150 | 151 | 150 | 149 |
| thickness 90% (nm) | | | | | | |
| Difference in | 26 | 20 | 15 | 11 | 19 | 24 |
| convex-region film | | | | | | |
| thickness 90%-10% | | | | | | |
| (nm) | | | | | | |
| Concave-region film | 250 | 265 | 300 | 370 | 270 | 240 |
| thickness 0% (nm) | | | | | | |
| Particle diameter (nm) | 170 | 170 | 170 | 170 | 170 | 170 |
| Particle diameter (nm) | 170 | 170 | 170 | 170 | 170 | 170 |
| (after 3 months) | | | | | | |

*Excluding poly carboxylic acid

TABLE 2

| | Comparative Example | | | | |
|---|---|---|---|---|---|
| | No. | | | | |
| | 1 | 2 | 3 | 4 | 5 |
| Polishing powder | 1 | 1 | 1 | 1 | 1 |
| concentration | | | | | |
| (wt. %) | | | | | |
| Polyacrylic acid | 0.27 | 0.27 | 0.27 | 0.27 | 0.27 |
| concentration | | | | | |
| (wt. %) | | | | | |
| Acid (pKa) | — | malic | succinic | acetic | Sulfuric |
| | | acid | acid | acid | acid |
| | | (3.24) | (4) | (4.56) | (<0) |
| Acid | <10 | 300 | 300 | 300 | 1200 |
| concentration* | | | | | |
| (ppm) | | | | | |
| PTEOS polishing | 278 | 215 | 290 | 264 | 85 |
| speed (nm/min) | | | | | |
| Si₃N₄ polishing | 7 | 8 | 7 | 9 | 12 |
| speed (nm/min) | | | | | |
| Pattern polishing | 180 | 210 | 170 | 190 | 380 |
| period (sec) | | | | | |
| Convex-region | 112 | 110 | 105 | 119 | 145 |
| film thickness | | | | | |
| 10% (nm) | | | | | |
| Convex-region | 148 | 148 | 147 | 148 | 152 |
| film thickness | | | | | |
| 90% (nm) | | | | | |
| Difference in | 36 | 38 | 42 | 29 | 7 |
| convex-region | | | | | |
| film thickness | | | | | |
| 90%-10% (nm) | | | | | |
| Concave-region | 220 | 310 | 190 | 270 | 410 |
| film thickness | | | | | |
| 0% (nm) | | | | | |
| Particle diameter | 170 | 170 | 170 | 170 | 180 |
| (nm) | | | | | |
| Particle diameter | 170 | 170 | 170 | 170 | 200 |
| (nm) | | | | | |
| (after 3 months) | | | | | |

*Excluding poly carboxylic acid

TABLE 3

| | | | | Comparative |
|---|---|---|---|---|
| No. | Example 7 | Example 8 | Example 9 | Example 6 |
| Synthetic | Poly | Poly | Poly | Poly |
| polycarboxylic | acrylic | acrylic | Acrylic- | acrylic acid |
| acid | acid | acid | methacrylic | |
| | | | acid | |
| Polishing powder | 1.0 | 1.0 | 1.0 | 1.0 |
| concentration | | | | |
| (wt. %) | | | | |
| Polycarboxylic | 0.27 | 0.27 | 0.27 | 0.27 |
| acid | | | | |
| concentration | | | | |
| (wt. %) | | | | |
| Acid contained in | Sulfuric | Sulfuric | Sulfuric | — |
| polymer (pKa) | acid (<0) | acid (<0) | acid (<0) | |
| Acid | 240 | 270 | 230 | <10 |
| concentration* | | | | |
| (ppm) | | | | |
| PTEOS polishing | 260 | 250 | 254 | 275 |
| speed (nm/min) | | | | |
| Si₃N₄ polishing | 8 | 8 | 8 | 7 |
| speed (nm/min) | | | | |
| Polishing period | 190 | 195 | 155 | 182 |
| (sec) | | | | |
| Convex-region | 128 | 126 | 139 | 113 |
| film thickness | | | | |
| 10% (nm) | | | | |
| Convex-region | 149 | 149 | 151 | 148 |
| film thickness | | | | |
| 90% (nm) | | | | |
| Difference in | 21 | 23 | 12 | 35 |
| convex-region | | | | |
| film thickness | | | | |
| 90%-10% (nm) | | | | |
| Concave-region | 240 | 250 | 210 | 220 |
| film thickness | | | | |
| 0% (nm) | | | | |
| Particle diameter | 170 | 170 | 170 | 170 |
| (nm) | (170) | (170) | (170) | (170) |
| (after 3 months) | | | | |

*Excluding polyacrylic acid and polyacrylic acid-methacrylic acid copolymers.

TABLE 4

| | Example | | | | Comparative Example | | |
|---|---|---|---|---|---|---|---|
| | No. | | | | | | |
| | 10 | 11 | 12 | 13 | 7 | 8 | 9 |
| Polishing | 1.0 | 1.0 | 1.0 | 1.0 | 1.0 | 1.0 | 1.0 |
| powder | | | | | | | |
| concentration | | | | | | | |
| (wt. %) | | | | | | | |
| Polyacrylic | 0.15 | 1.0 | 0.27 | 0.18 | 0.15 | 1.5 | 0.18 |
| acid | | | | | | | |
| concentration | | | | | | | |
| (wt. %) | | | | | | | |
| Acid (pKa) | Sulfuric | Sulfuric | Sulfuric | Nitric | Sulfuric | Sulfuric | Nitric |
| | acid | acid | acid | acid | acid | acid | acid |
| | (<0) | (<0) | (<0) | (−1.8) | (<0) | (<0) | (−1.8) |
| Acid | 300 | 1000 | 300 | 520 | 300 | 1000 | 1200 |
| concentration* | | | | | | | |
| (ppm) | | | | | | | |
| Polishing | 4.2 | 7.0 | 5.0 | 4.8 | 3.9 | 7.6 | 4.8 |
| slurry pH | | | | | | | |
| PTEOS polishing | 120 | 300 | 262 | 55 | 70 | 360 | 25 |
| speed (nm/min) | | | | | | | |
| Si₃N₄ polishing | 10 | 6 | 7 | 7 | 15 | 7 | 8 |
| speed (nm/min) | | | | | | | |
| Pattern | 335 | 160 | 185 | 400 | 415 | 140 | >450 |
| polishing | | | | | | | |
| period (sec) | | | | | | | |
| Convex-region | 137 | 125 | 129 | 140 | 130 | 95 | 148 |
| film thickness | | | | | | | |
| 10% (nm) | | | | | | | |
| Convex-region | 151 | 148 | 150 | 151 | 151 | 149 | >100 |
| film thickness | | | | | | | Oxide |
| 90% (nm) | | | | | | | |
| Difference in | 14 | 23 | 21 | 11 | 21 | 54 | >100 |
| convex-region | | | | | | | |
| film thickness | | | | | | | |
| 90%-10% (nm) | | | | | | | |
| Concave-region | 340 | 220 | 260 | 420 | 350 | 190 | 460 |
| film thickness | | | | | | | |
| 0% (nm) | | | | | | | |
| Particle diameter | 170 (180) | 170 (180) | 170 (170) | 170 (170) | 180 (200) | 180 (200) | 180 (200) |
| (nm) | | | | | | | |
| (after 3 months) | | | | | | | |

*Excluding polyacrylic acid

The polishing slurries obtained in Examples 1 to 6, which contain a polyacrylic acid and also a strong acid, show a smaller difference in convex-region film thickness in pattern polishing than that of the polishing slurry obtained in Comparative Example 1 that contains no strong acid. The polishing slurries obtained in Examples 7 to 9, which contain a polyacrylic acid or polyacrylic-methacrylic acid containing a sulfuric acid, show a smaller difference in convex-region film thickness between pattern densities in pattern polishing than the polishing slurry obtained in Comparative Example 6 that contains no sulfuric acid. The polishing slurries obtained in Examples 10 and 11 show a smaller difference in convex-region film thickness between pattern densities in pattern polishing when the contents of the polyacrylic acid and sulfuric acid are adjusted according to the pH of the polishing slurry, but have a tendency toward enlargement of the cerium oxide particle diameter after storage for three months and thus, to some decline in dispersion stability after long-term storage when the pH of the polishing slurry is low in the range close to 4 or high in the range close to 7.5. The polishing slurry in Example 12 also shows a similar effect when it contains a strong acid salt. The polishing slurry in Example 13 that contains a previously neutralized ammonium salt as the polyacrylic acid and is pH-adjusted with a nitric acid has a nitrate ion concentration in the polishing slurry in the range of the present invention and shows a similar effect.

The polishing slurries obtained in Comparative Examples 2 to 4, which contain a polyacrylic acid and a weak acid having a pKa of more than 3.2, do not show a lowered difference in convex-region film thickness between pattern densities in pattern polishing. The polishing slurry obtained in Comparative Example 5, which contains a polyacrylic acid as well as a strong acid, results in enlargement of the particle diameter immediately after mixing of the cerium oxide polishing slurry and elongation of the pattern polishing period (>350 seconds), because the sulfuric acid content 1,200 ppm is too high. The polishing slurries obtained in Comparative Examples 7 and 8 are different from each other in polishing slurry pH, and the polishing slurry in Comparative Example 7 does not show sufficient polishing speed because of excessively low polishing slurry pH (pH 3.9), results in elongation of pattern polishing period (>400 seconds), and shows a tendency toward enlargement of the cerium oxide particle diameter immediately after mixing of the polishing slurry. The polishing slurry in Comparative Example 8 does not show the advantageous effects of containing a polyacrylic acid and a sulfuric acid because of an excessively high polishing slurry pH (pH 7.6), and shows a tendency toward enlargement of the cerium oxide particle diameter immediately after mixing of the polishing slurry. The polishing slurry in Comparative Example 9 that contains an excessively neutralized ammonium salt as the polyacrylic acid and pH-adjusted with a nitric acid gives some unpolished areas even after pattern wafer polishing for 450 seconds, because the nitrate ion concentration 1,200 ppm in the polishing slurry is too high, and shows a tendency toward enlargement of the cerium oxide particle diameter immediately after mixing of the polishing slurry and deterioration in dispersion stability.

### INDUSTRIAL APPLICABILITY

The present invention provides a polishing slurry and a polishing method for polishing a silicon oxide film or the like, that allow high speed operation and easier process management and cause smaller fluctuation in film thickness due to difference in pattern density, for use in the CMP methods of surface-smoothening an interlayer dielectric film, a BPSG film and a shallow-trench-isolation insulation film or the like.

1. A CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less and the concentration of the strong acid in the polishing slurry is 100 to 1,000 ppm.

2. A CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less and the concentration of the strong acid in the polishing slurry is 50 to 1,000 ppm.

3. A CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less, the strong acid in the polishing slurry is a monovalent strong acid, and the concentration thereof is 50 to 500 ppm.

4. A CMP polishing slurry, containing cerium oxide particles, a dispersant, a polycarboxylic acid, a strong acid having a pKa of its first dissociable acidic group at 3.2 or less, and water, characterized in that the pH of the polishing slurry is 4.0 or more and 7.5 or less, the strong acid in the polishing slurry is a bivalent strong acid, and the concentration thereof is 100 to 1,000 ppm.

5. The CMP polishing slurry according to claim 1 or 4, wherein the concentration of the strong acid in the polishing slurry is 200 to 1,000 ppm.

6. The CMP polishing slurry according to claim 1 or 4, wherein the concentration of the strong acid in the polishing slurry is 300 to 600 ppm.

7. The CMP polishing slurry according to claim 1 or 4, wherein the strong acid is a sulfuric acid.

8. The CMP polishing slurry according to claim 2 or 3, wherein the concentration of the strong acid in the polishing slurry is 100 to 500 ppm.

9. The CMP polishing slurry according to claim 2 or 3, wherein the concentration of the strong acid in the polishing slurry is 150 to 300 ppm.

10. The CMP polishing slurry according to any one of claims 1 to 4, wherein the pKa of the first dissociable acidic group of the strong acid is 2.0 or less.

11. The CMP polishing slurry according to claim 10, wherein the pKa of the first dissociable acidic group of the strong acid is 1.5 or less.

12. The CMP polishing slurry according to any one of claims 1 to 4, wherein the pH of the polishing slurry is 4.5 or more and 5.5 or less.

13. The CMP polishing slurry according to any one of claims 1 to 4, wherein the polycarboxylic acid is a polyacrylic acid.

14. The CMP polishing slurry according to any one of claims 1 to 4, wherein the dispersant is a polymer compound containing an ammonium acrylate salt.

15. The CMP polishing slurry according to any one of claims 1 to 4, wherein the polishing slurry is prepared by mixing an unneutralized polycarboxylic acid, a strong acid or a strong acid salt, and water and adjusting the pH of the mixture with ammonia.

16. The CMP polishing slurry according to any one of claims 1 to 4, wherein the content of the cerium oxide particles is 0.1 weight part or more and 5 weight parts or less with respect to 100 weight parts of the CMP polishing slurry.

17. The CMP polishing slurry according to any one of claims 1 to 4, wherein the content of the polycarboxylic acid is 0.01 weight part or more and 2 weight parts or less with respect to 100 weight parts of the CMP polishing slurry.

18. The CMP polishing slurry according to any one of claims 1 to 4, wherein the weight-average molecular weight of the polycarboxylic acid is 500 or more and 20,000 or less (by GPC as PEG).

19. The CMP polishing slurry according to any one of claims 1 to 4, wherein the average particle diameter of the cerium oxide particles is 1 nm or more and 400 nm or less.

20. The CMP polishing slurry according to any one of claims 1 to 4, wherein the polycarboxylic acid is a polymer obtained by polymerization of a monomer containing at least one of carboxylic acid having an unsaturated double bond and the salt thereof by using at least one of cationic or anionic azo compound and the salt thereof as a polymerization initiator.

21. The CMP polishing slurry according to any one of claims 1 to 4, characterized by being prepared by mixing a cerium oxide slurry containing cerium oxide particles, the dispersant and water with a supplementary solution containing the polycarboxylic acid, the strong acid, a pH adjuster and water.

22. A method of producing the CMP polishing slurry according to any one of claims 1 to 4, characterized by including: a step of preparing an aqueous solution containing an unneutralized polycarboxylic acid, a strong acid or a strong acid salt, and water; and a step of adjusting the pH of the aqueous solution with ammonia.

23. A method of producing the CMP polishing slurry according to any one of claims 1 to 4, characterized by including a step of mixing a cerium oxide slurry containing cerium oxide particles, a dispersant and water with a supplementary solution containing a polycarboxylic acid, a strong acid and water.

24. A method of polishing a substrate, characterized by pressing a substrate having a formed film to be polished onto a polishing cloth of a polishing table, and polishing the film to be polished by moving the substrate and the polishing table relatively to each other while supplying the CMP polishing slurry according to any one of claims 1 to 4 into the space between the film to be polished and the polishing cloth.
